(19) United States
(12) Patent Application Publication
(10) Pub. No.: US 2001/0045876 A1
(43) Pub. Date: Nov. 29, 2001

(54) Dielectric laminated device and manufacturing method thereof

(76) Inventors: Emiko Kawahara, Osaka (JP); Toru Yamada, Osaka (JP); Hiroshi Kagata, Osaka (JP)

Correspondence Address: SMITH, GAMBRELL & RUSSSELL, LLP, Suite 800, 1850 M Street, N.W., Washington, DC, 20036, US

(21) Appl. No.: 09/862,611

(22) Filed: May 23, 2001

(30) Foreign Application Priority Data
May 25, 2000 (JP) 2000-154,495

(51) Int. Cl. H01P 1/203

(52) U.S. Cl. 333/204; 333/219

(57) ABSTRACT

A dielectric laminated device, has a layered product including a plurality of dielectric layers; and

a plurality of strip line conductors arranged in the interior of the layered product,

wherein the thickness of at least part of the side part of at least one strip line conductor among the plurality of strip line conductors is thicker than that of the central part.

### BACKGROUND OF THE INVENTION

1. Field of the Invention

The present invention relates to a dielectric laminated device that is mainly used for high frequency radio equipment or the like such as a portable telephone.

2. Description of the Prior Art

Recently, as the communication equipment becomes miniaturized, the dielectric laminated device that is advantageous for the miniaturization is often used as a high frequency device. One example of the above described conventional dielectric laminated device will be described below while referring to the drawings.

FIG. 4 is a drawing showing an exploded illustration of a strip line conductor of a conventional dielectric laminated device that is formed by normal screen printing. In FIG. 4, reference numerals 101a, 101b, 101c, 101d, 101e denote dielectric layers, and reference numerals 102a, 102b denote shield conductors, and reference numerals 403a, 403b, 104a, 104b, 104c denote strip line conductors, and reference numerals 105a, 105b, 106a, 106b, 106c, 106d, 106e, 106f denote external conductors.

In the interior of the layered product composed of dielectric layers 101a to 101e, the shield conductor 102a, the strip line conductors 403a, 403b, the strip line conductors 104a, 104b, 104c, and the shield conductor 102b are arranged between the dielectric layers in turn, and furthermore, the external conductors 106a, 106b, 106c, 106e, and 106f in front and on the left and right sides of the layered product connect the shield conductors 102a, 102b and form the ground terminal, and the external conductor 106d on the rear of the layered product connects the common short-circuit ends of the shield conductors 102a, 102b and the strip line conductors 403a, 403b, and becomes the ground terminal, the external conductors 105a, 105b on the left and right sides of the layered product are connected to the strip line conductors 104a, 104b, respectively, and form the input and output terminals.

As for the dielectric laminated device composed as mentioned above, the function thereof will be described below.

The strip line conductors 403a, 403b compose a resonator of the quarter wavelength short-circuit type, and the strip line conductor 104c forms a capacitor by being arranged facing to part of the above described strip line conductors 403a, 403b, and connects the above described resonator of the quarter wavelength short-circuit type, and the strip line conductors 104a, 104b form a capacitor by being arranged facing to part of the above described strip line conductors 403a, 403b, respectively, and function as the input and output terminals by connecting one of the above described strip line conductors 104a, 104b and the external conductors 105a, 105b, respectively. Accordingly, the dielectric laminated device in FIG. 4 functions as a band-pass filter in which the external conductors 105a, 105b are the input and output terminals.

### BRIEF SUMMARY OF THE INVENTION

Object of the Invention

However, in such a construction as mentioned above, the edge angle of a side part of the strip line conductor becomes small, and the conductor loss because of the concentration of electric field to the side pointed part becomes large, and therefore, the loss as the filter characteristics also becomes large. “Edge angle becomes small” in the above description will be described by using FIG. 5.

FIG. 5 is one end face view when the conventional dielectric laminated device shown in FIG. 4 is cut by a plane substantially at right angles to the strip line conductors 403a, 403b that have substantially parallel relation. As shown in FIG. 5, the angle of the edge part 1403 of the strip line conductors 403a, 403b is small, and therefore, the concentration of electric field to that edge part 1403 is caused.

When the total of the strip line conductors 403a, 403b is made uniformly thick, and the angle of the edge part is made large in order to solve this problem, the stress applied to the interior of the laminated device at the time of dropping the temperature in the burning process or at the time of solder re-flow or the like becomes large by the difference in the heat expansion ratio between the metal to be the conductor and the dielectric layer. By this increased stress, a crack is caused in the laminated device, and as a result of that, there has been such a problem that the degradation of electric characteristics or the lowering of mechanical strength is caused.

Furthermore, there has been a deviation in the distribution of the current flowing in the strip line conductor 403. That deviation in the distribution of the current will be described by using FIG. 10. FIG. 10 is a figure showing the distribution of the current flowing in the strip line conductor 403a in FIG. 4 that composes the resonator of the quarter wavelength. As shown in FIG. 10, it is apparent that the distribution of the current is large on the short-circuit end side, and small on the open end side. By the way, the thickness of the conventional strip line conductor 403a has substantially been uniform, and therefore, in the strip line conductor 403a, the conductor loss on the short-circuit end side where current is concentrated is bigger than the conductor loss on the open end side. That is, it was equivalent to the resistance the short-circuit end side where current is concentrated is bigger than the resistance on the open end side. Therefore, there has been such a problem that the loss as the filter characteristics is also large. This problem has also been caused similarly in the strip line conductor 403b.

Furthermore, a similar problem has also been caused in the strip line conductor composing the resonator of the half wavelength. In FIG. 11, the distribution of the current flowing in the strip line conductor composing the resonator of the half wavelength is shown. As shown in FIG. 11, it is apparent that a part where a lot of current flows exists in the central part in the case of the strip line conductor composing the resonator of the half wavelength. The thickness of the conventional strip line conductor has been substantially uniform, and therefore, in the strip line conductor composing the resonator of the half wavelength, the resistance value on the short-circuit end side at the central part has been larger than the resistance value on the open end side, and therefore, there has been such a problem that the loss as the filter characteristics is also large.

The present invention is achieved due to the above described problems, and it is an object thereof to provide a dielectric laminated device in which it is difficult to cause the concentration of electric field to be the source of the increase of the loss of the conductor.

Furthermore, it is an object of the present invention to provide a dielectric laminated device in which the resistance of the strip line conductor is more leveled than that of the prior art.

The 1st invention of the present invention is a dielectric laminated device, comprising:

a layered product including a plurality of dielectric layers; and

a plurality of strip line conductors arranged in the interior of the layered product,

wherein the thickness of at least part of the side part of at least one strip line conductor among said plurality of strip line conductors is thicker than that of the central part.

The 2nd invention of the present invention is the dielectric laminated device according to 1st invention, wherein said at least one strip line conductor forms a resonator of the quarter wavelength tip short-circuit type, and the thickness of the side part on the short-circuit end side of the resonator is thicker than that of the central part.

The 3rd invention of the present invention is the dielectric laminated device according to 1st invention, wherein said at least one strip line conductor forms a resonator of the half wavelength tip open type, and the thickness of the side part at a part substantially separated from the open end by quarter wavelength in the wavelength direction of the resonator is thicker than that of the central part.

The 4th invention of the present invention is a manufacturing method of a dielectric laminated device, having a layered product including a plurality of dielectric layers; and a plurality of strip line conductors arranged in the interior of the layered product, said method comprising:

a step of forming a strip line conductor in which the thickness of at least one side part is thicker than that of the central part on a specified dielectric layer material, and a step of pressing and laminating another dielectric layer material thereon.

The 5th invention of the present invention is a dielectric laminated device, comprising:

a layered product including a plurality of dielectric layers; and

a plurality of strip line conductors arranged in the interior of the layered product,

wherein the thickness of a part having more electric current concentrated is thicker than that of a part having less electric current concentrated, in at least one strip line conductor among said plurality of strip line conductors,

The 6th invention of the present invention is the dielectric laminated device according to 5th invention, wherein said at least one strip line conductor forms a resonator of the quarter wavelength tip short-circuit type, and the thickness on the short-circuit end side of the resonator is thicker than that on the open end side.

The 7th invention of the present invention is the dielectric laminated device according to 5th invention, wherein said at least one strip line conductor forms a resonator of the half wavelength tip open type, and the thickness of a part substantially separated from the open end of the resonator by quarter wavelength is thicker than that of the open end part.

The 8th invention of the present invention is a manufacturing method of a dielectric laminated device, having a layered product including a plurality of dielectric layers; and a plurality of strip line conductors arranged in the interior of the layered product, said method comprising:

a step of forming a strip line conductor in which the thickness of a part having more electric current concentrated is thicker than that of a part having less electric current concentrated on a specified dielectric layer material, and a step of pressing and laminating another dielectric layer material thereon.

The 9th invention of the present invention is the dielectric layered device according to any one of 1st, 2nd, 3rd, 5th, 6th, 7th inventions, wherein an inside material and an outside material are different at a part in which the thickness of said strip line conductor is relatively thick.

The 10th invention of the present invention is the dielectric laminated device according to 1st invention, wherein a plurality of shield conductors are arranged in the interior of said layered product, and at least two resonators of the quarter wavelength tip shot-circuit type and a strip line conductor facing to part of said resonators of the quarter wavelength tip short-circuit type are arranged between said plurality of shield conductors, and the strip line conductor connects said two resonators of the quarter wavelength tip short-circuit type to each other and forms a multi-stage filter, and the thickness of part of said resonators of the quarter wavelength tip short-circuit type is thicker than that of the other part.

The 11th invention of the present invention is Communication equipment, comprising:

a transmitter; and

a receiver,

wherein the dielectric laminated device according to any one of 1st, 2nd, 3rd, 5th, 6th, 7th, 10th inventions is included as an element.

### BRIEF DESCRIPTION OF THE DRAWINGS

FIG. 1 is an exploded illustration of a dielectric laminated device in a first embodiment of the present invention;

FIG. 2 is a cross sectional view of an electrode of the dielectric laminated device in the first embodiment of the present invention;

FIG. 3 is an exploded illustration of the dielectric laminated device in a second embodiment of the present invention;

FIG. 4 is an exploded illustration of the conventional dielectric laminated device;

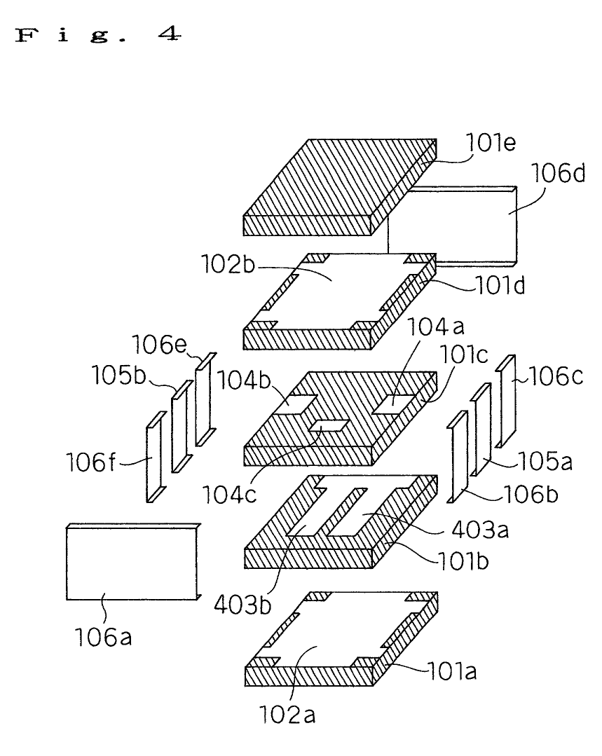

FIG. 5 is a cross sectional view of the electrode of the conventional dielectric laminated device;

FIG. 6 is an exploded illustration of the dielectric laminated device in the second embodiment of the present invention;

FIG. 7 is an exploded illustration of the dielectric laminated device in the first embodiment of the present invention;

FIG. 8 is an exploded illustration of the dielectric laminated device in the second embodiment of the present invention;

FIG. 9 is an exploded illustration of the dielectric laminated device in the second embodiment of the present invention;

FIG. 10 is a view showing the distribution of the current flowing in a strip line conductor composing a resonator of the quarter wavelength; and

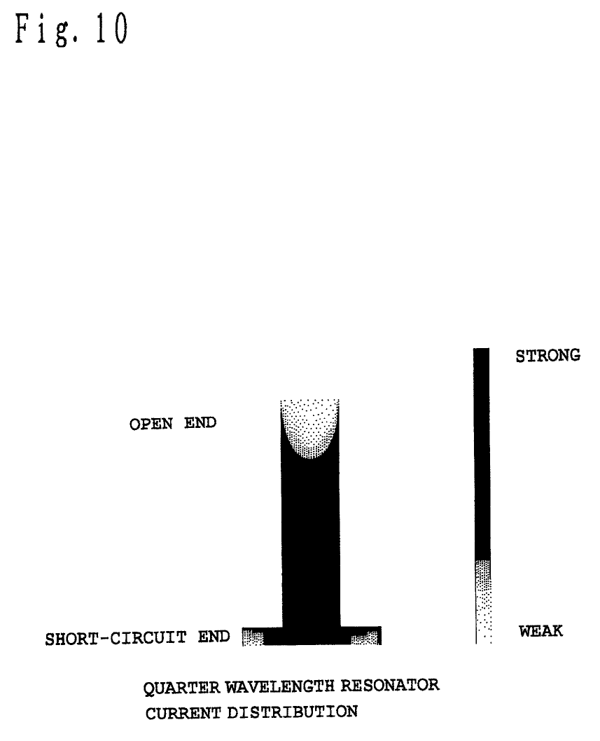

FIG. 11 is a view showing the distribution of the current flowing in the strip line conductor composing the resonator of the half wavelength.

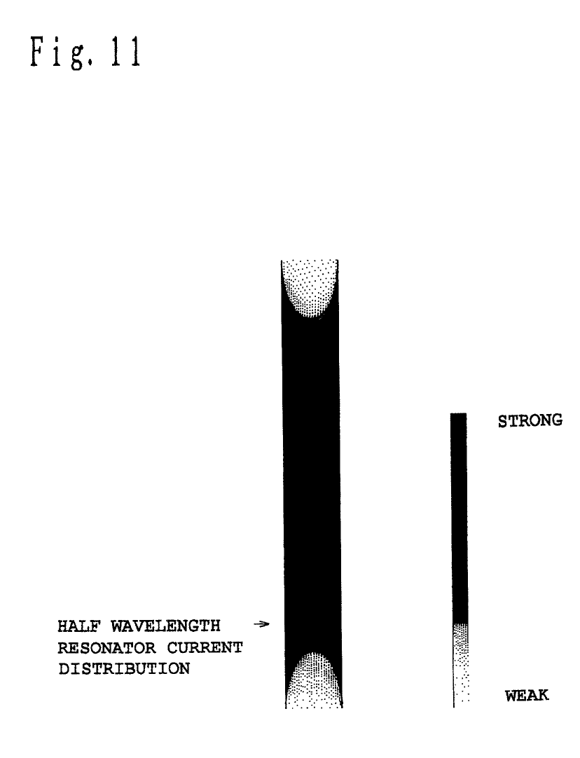

### DESCRIPTION OF SYMBOLS

100 layered product

101 dielectric layer

shield conductor

103, 104, 303, 403, 703 strip line conductor

105, 106 external conductor

1103 side part

1104 central part

1105 conductor on surface of strip line conductor 103

1106 interior of strip line conductor 103

### DETAILED DESCRIPTION OF THE PREFERRED EMBODIMENTS

The preferred embodiments of the present invention will be described below by referring to the drawings.

(First Embodiment)

The dielectric laminated device of a first embodiment of the present invention will be described while referring to the drawings.

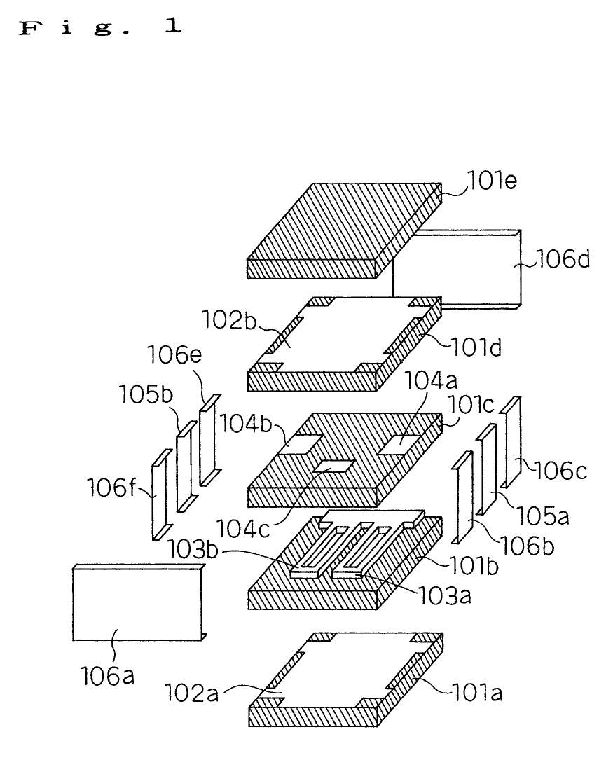

FIG. 1 is a drawing showing an exploded illustration of the dielectric laminated device in the first embodiment of the present invention. In FIG. 1, reference numeral 101 denotes the dielectric layer, and reference numeral 102 denotes the shield conductor, and reference numerals 103, 104 denote the strip line conductors, and reference numerals 105, 106 denote the external conductors.

Here, the laminated structure of the dielectric laminated device of this first embodiment will be described. On the upside of the first dielectric layer 101a, the first shield conductor 102a is arranged, and on the upper side of that conductor 102a, the second dielectric layer 101b is laminated, and on the upside of that dielectric layer 101b, two strip line conductors 103a, 103b are arranged.

Furthermore, on the upper side of those conductors 103, the third dielectric layer 101c is laminated, and on the upside of that dielectric layer 101c, three strip line conductors 104a, 104b, 104c are arranged. Furthermore, on the upper side of those conductors 104, the fourth dielectric layer 101d is laminated, and on the upside of that dielectric layer 101d, the second shield conductor 102b is arranged, and on the upper side of that conductor 102b, the fifth dielectric layer 101e is laminated. Thus, the laminated structure of the dielectric laminated device is formed.

Furthermore, in front of the layered product composed of the dielectric layers 101a to 101e, the external conductor 106a is provided, and on the side of the layered conductor, the external conductors 105a, 105b, 106b, 106c, 106d, 106e are provided, and furthermore, on the rear of the layered product, the external conductor 106d is provided. The connecting relation between these external conductors and the electrode formed on each dielectric layer will be described next.

The first shield conductor 102a, the short-circuit end on the rear side of the layered product to which both the strip line conductors 103a, 103b are connected together, and the second shield conductor 102b are connected by the external conductor 106d and are grounded. Furthermore, the strip line conductor 104a and the external conductor 105a are connected, and the strip line conductor 104b and the external conductor 105b are connected. Furthermore, the first shield conductor 102a and the second shield conductor 102b are connected by the external conductors 106a, 106b, 106c, 106e, and 106f and are grounded, and furthermore, the external conductors 106b, 106f are connected to the external conductor 106a, and the external conductors 106c, 106e are connected to the external conductor 106d.

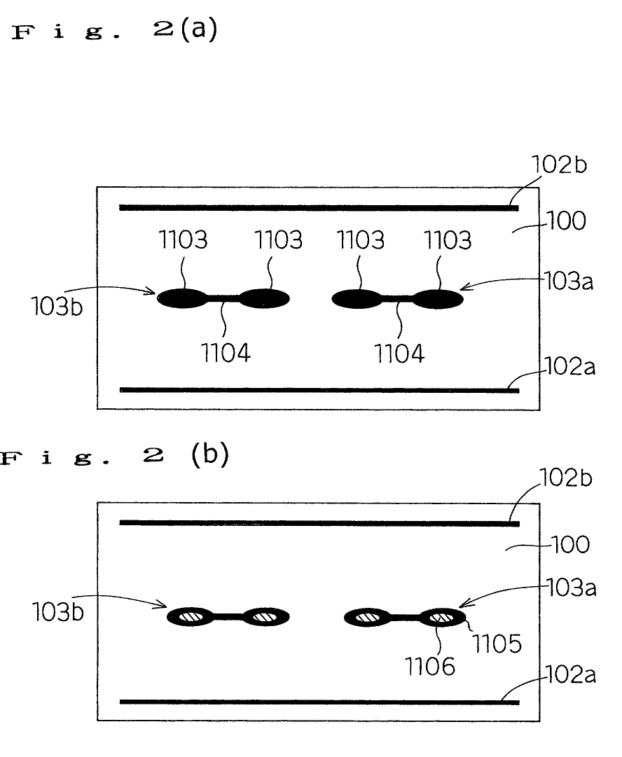

By the way, as shown in FIG. 1 and FIG. 2A, in the above described strip line conductors 103a and 103b, the thickness of the side part 1103 thereof is formed to be tens of times the skin depth of the micro wave band. For example, if the strip line conductors 103a and 103b are composed of silver, the skin depth at 2 GHz band is about 1.5 μm, and the thickness of the above described side part 1103 is formed to be 30 μm or more. Furthermore, FIG. 2A is one end face view when the dielectric laminated device of the first embodiment in FIG. 1 is cut by a plane substantially at right angles to the strip line conductors 103a, 103b that have substantially parallel relation.

As for the dielectric laminated device of the first embodiment composed as mentioned above, the function thereof will be described below by using FIG. 1 and FIG. 2.

The strip line conductors 103a, 103b are grounded through the external conductor 106d, and form a resonator of the quarter wavelength tip short-circuit type, and the strip line conductor 104c forms a capacitor by being arranged facing to part of the above described strip line conductors 103a, 103b respectively, and it functions as an inter-section coupling capacitance.

Furthermore, the strip line conductor 104a is arranged facing to part of the strip line conductor 103a, and the strip line conductor 104b is arranged facing to part of the strip line conductor 103b, and each forms a capacitor, and the strip line conductor 104a is connected to the external conductor 105a, and the strip line conductor 104b is connected to the external conductor 105b, and they form the input and output terminals. Accordingly, the dielectric laminated device in FIG. 1 functions as a band pass filter in which the external conductors 105a, 105b are the input and output terminals.

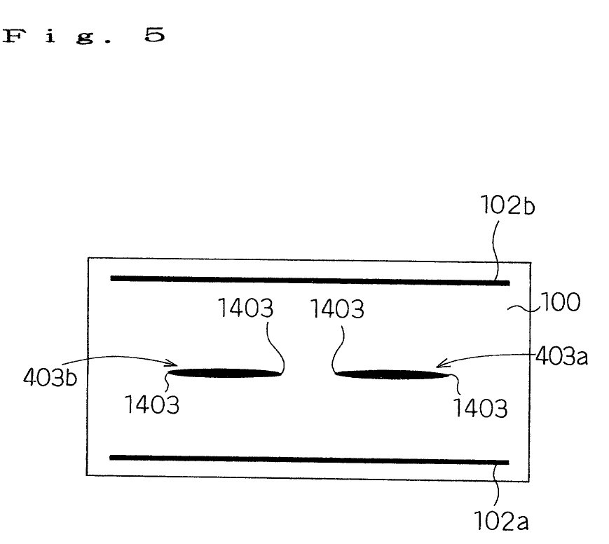

Furthermore, as mentioned above, FIG. 2A is a drawing showing an end face view of the electrode of the dielectric laminated device shown in FIG. 1, and it has a side part 1103 with an edge angle larger than that of the side pointed part 1403 (refer to FIG. 5) of the conventional strip line conductor, and the conductor loss because of the concentration of electric field to the side part 1103 of the strip line conductor is restrained.

Furthermore, in order to make the thickness of the side part 1103 of the strip line conductors 103a and 103b thicker than that of the central part 1104, as shown in FIG. 1, the strip line conductors 103a, 103b in which the thickness of the side part is thicker than that of the central part have been formed in advance on the dielectric layer 101b before laminating the dielectric layers 101a to 101e.

If doing so, the thickness of the strip line conductors 103a, 103b are not uniformly thick, and therefore, at the time of burning the layered product 100 made by laminating the dielectric layers 101a to 101e, the stress because of the difference in heat contraction can be restrained to the minimum, and Generating of a crack is restrained. One end face of the strip line conductors 103a, 103b of the layered product 100 after the burning can be shown in FIG. 2A.

Next, the manufacturing method of the dielectric laminated device of the present invention will be described. The forming method of each conductor uses a method by the normal screen printing, and the laminating of the dielectric green sheet and the printing of the conductor pattern are performed in turn, and after the integration by the press crimping and the burning, the external conductor is printed and baked. Furthermore, the strip line conductor 103 is formed such that the pattern of the strip line conductor is printed on the upside of the dielectric green sheet 101b and dried, and after that, the pattern of only the side part of the strip line conductor is overlapped and printed to the above described strip line conductor. According to the above described method, the strip line conductor having such a cross sectional form as shown in FIG. 2 can be obtained.

Furthermore, in the case where each conductor pattern is laminated and press-crimped to be unified in turn after each has been printed and formed on the dielectric green sheet, the strip line conductor having a similar cross sectional form can also be obtained.

As mentioned above, according to the present embodiment, the conductor loss of the strip line conductor can be decreased by increasing the edge angle of the side part 1103 of the strip line conductor, and if the above described strip line conductor is used as a resonator, the loss as the filter characteristics can also be improved. Furthermore, only the side part 1103 is thick, and therefore, it is possible to restrain the occurrence of a crack because of the difference in the heat expansion ratio between the dielectric and the conductor.

Furthermore, the similar effect can also be obtained in the case where as shown in FIG. 2B, the interior 1106 of the strip line conductor 103 is made of a material different from that of the conductor 1105 of the surface in the side part 1103 shown in FIG. 2A. The material of the interior 1106 of the strip line conductor is not specifically limited as long as it is a material different from that of the conductor 1105 of the surface, but it is preferably be, for example, a material having a conductivity lower than that of the above described conductor 1105, a material having a heat expansion ratio equal to that of the above described dielectric, or a material having the middle heat expansion ratio between the heat expansion ratio of the above described dielectric and the heat expansion ratio of the above described conductor.

Consequently, the stress because of the difference in the heat contraction of the thickened part of the strip line conductor can furthermore be decreased, and it is possible to restrain the lowering of the mechanical strength because of the internal crack and the degradation of the electric characteristics.

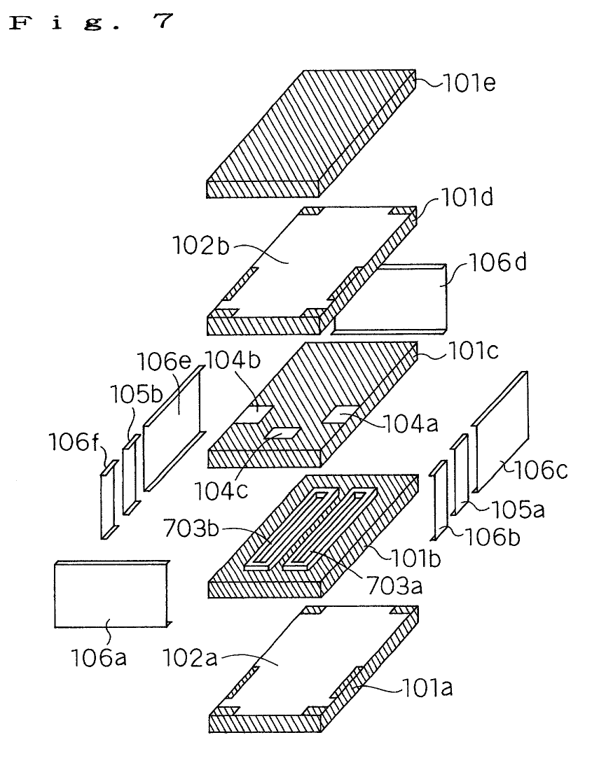

Furthermore, the similar effect can also be obtained even in the case where the above described resonator 103 of the quarter wavelength tip short-circuit type is a resonator of the half wavelength tip open type like the strip line conductor 703 in FIG. 7.

(Second Embodiment)

The dielectric laminated device of a second embodiment of the present invention will be described below while referring to the drawings.

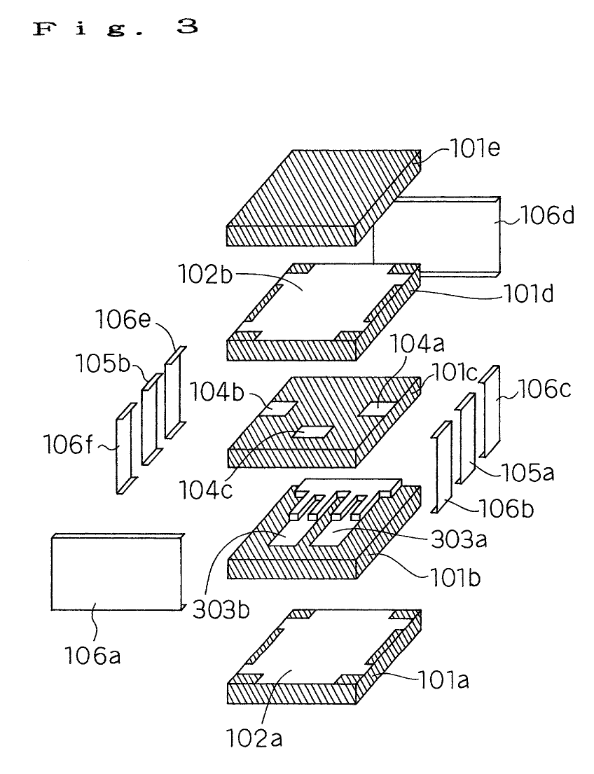

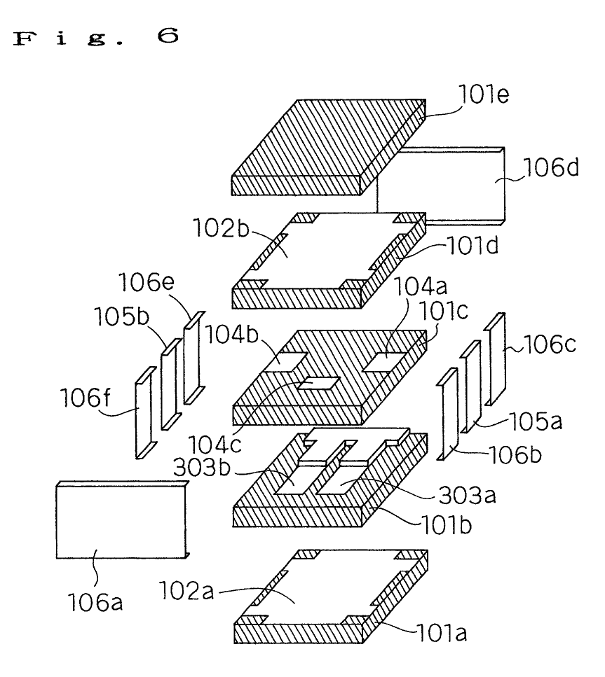

FIG. 3 and FIG. 6 are exploded illustrations of the dielectric laminated device of the second embodiment of the present invention. The laminated structure and the function are similar to those of the first embodiment, and the same numerals are given to the corresponding elements. It is different from that of the first embodiment in that the strip line conductor 303 has a part thicker than the other part provided near the connecting part with the external conductor.

As mentioned above, according to the present embodiment, in the resonator of the quarter wavelength tip short-circuit type, the current is concentrated at a position near the short-circuit end, and especially at the side part thereof, and therefore, the resistance near the short-circuit end can be made smaller than that of the prior art in such a way that the total is not made thick and only the part near the short-circuit end where the current is concentrated is made thick. That is, in the resonator of the quarter wavelength tip open type, the resistance value can also be leveled, and consequently, the conductor loss can be restrained.

Furthermore, by increasing the thickness of the short-circuit end of the strip line conductor, the contact resistance with the external conductor can be decreased, and if the above described strip line conductor is used as a resonator, the loss as the filter characteristics can also be improved.

Furthermore, the strip line conductor near the open end is thin, and therefore, if the strip line conductors 104 are arranged facing at this part, the swell of the strip line conductor is small, and it is possible to stably form the inter-section coupling capacitance and the input and output capacitance, and there is also an effect in improving the yield rate.

Furthermore, the similar effect can be obtained, not only in the case of the design of the inter-section coupling capacitance and the input and output capacitance but also in all cases of forming the capacitor, by arranging part of the resonator such as the loading capacitance and part of the strip line conductor facing to each other.

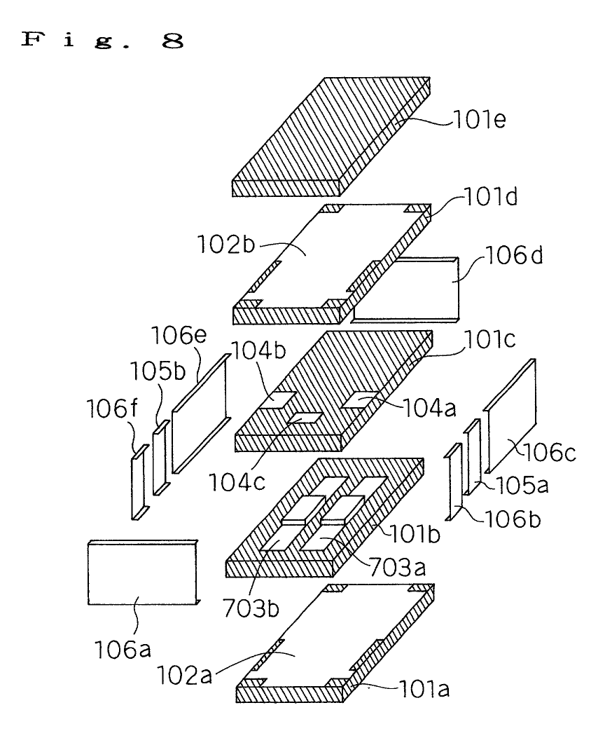

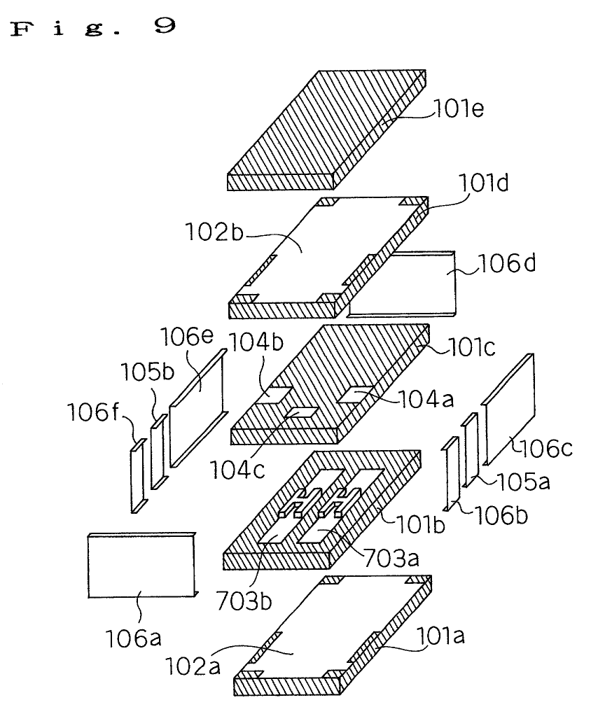

Furthermore, in the case of the resonator of the half wavelength tip open type, the resistance at the part where the current is concentrated can also be made smaller than that of the prior art, by making a part (703 in FIG. 8) near the part separated by quarter wavelength from the open end where the current is concentrated, or the side part thereof (703 in FIG. 9) thick. That is, in the case of the resonator of the half wavelength tip open type, the resistance value can also be leveled.

Furthermore, in each of the above described embodiments, the description has been given as for the case of the two stage band pass filter, but the similar effect can also be obtained in the case of various kinds of filters such as a low-pass filter, a by-pass filter or a band-illumination filter, or a multi-stage filter of three stages or more. Furthermore, in each of the above described embodiments, the edge angle of the resonator is made large, but the similar effect can also be obtained by using this structure in the main line such as the inductor composing the above described various kinds of filters.

Furthermore, in the communication equipment having a transmitter and a receiver, communication equipment including the dielectric laminated device according to the above described embodiments as an element also belongs to the present invention. That dielectric laminated device may be provided in the interior of the transmitter or the receiver, or it may be provided separately and independently from the transmitter or the receiver.

As mentioned above, the dielectric laminated device of the present invention has a large edge angle by thickening the side part of the strip line conductor, and it is possible to improve the conductor loss because of the concentration of the electric field to both end pointed parts. Furthermore, since only the pointed part is thick, it is possible to restrain the occurrence of a crack because of the difference in the heat expansion ratio between the dielectric and the conductor, and it is possible to prevent the degradation of the electric characteristics and the lowering of the mechanical strength. Furthermore, by increasing the thickness of the short-circuit end of the strip line conductor, the contact resistance with the external conductor can be decreased, and if the above described strip line conductor is used as a resonator, the loss as the filter characteristics can also be improved. Furthermore, if only the part near the short-circuit end of the above described strip line conductor is made thicker than other parts, the swell of the facing strip line conductors is small when forming the capacitor near the open end, and the design of the capacitance can be easily be performed.

What is claimed is:

1. A dielectric laminated device, comprising:
a layered product including a plurality of dielectric layers; and
a plurality of strip line conductors arranged in the interior of the layered product,
wherein the thickness of at least part of the side part of at least one strip line conductor among said plurality of strip line conductors is thicker than that of the central part.

2. The dielectric laminated device according to claim 1, wherein said at least one strip line conductor forms a resonator of the quarter wavelength tip short-circuit type, and the thickness of the side part on the short-circuit end side of the resonator is thicker than that of the central part.

3. The dielectric laminated device according to claim 1, wherein said at least one strip line conductor forms a resonator of the half wavelength tip open type, and the thickness of the side part at a part substantially separated from the open end by quarter wavelength in the wavelength direction of the resonator is thicker than that of the central part.

4. A manufacturing method of a dielectric laminated device, having a layered product including a plurality of dielectric layers; and a plurality of strip line conductors arranged in the interior of the layered product, said method comprising:
a step of forming a strip line conductor in which the thickness of at least one side part is thicker than that of the central part on a specified dielectric layer material, and a step of pressing and laminating another dielectric layer material thereon.

5. A dielectric laminated device, comprising:
a layered product including a plurality of dielectric layers; and
a plurality of strip line conductors arranged in the interior of the layered product,
wherein the thickness of a part having more electric current concentrated is thicker than that of a part having less electric current concentrated, in at least one strip line conductor among said plurality of strip line conductors.

6. The dielectric laminated device according to claim 5, wherein said at least one strip line conductor forms a resonator of the quarter wavelength tip short-circuit type, and the thickness on the short-circuit end side of the resonator is thicker than that on the open end side.

7. The dielectric laminated device according to claim 5, wherein said at least one strip line conductor forms a resonator of the half wavelength tip open type, and the thickness of a part substantially separated from the open end of the resonator by quarter wavelength is thicker than that of the open end part.

8. A manufacturing method of a dielectric laminated device, having a layered product including a plurality of dielectric layers; and a plurality of strip line conductors arranged in the interior of the layered product, said method comprising:
a step of forming a strip line conductor in which the thickness of a part having more electric current concentrated is thicker than that of a part having less electric current concentrated on a specified dielectric layer material, and a step of pressing and laminating another dielectric layer material thereon.

9. The dielectric layered device according to any one of claims 1, 2, 3, 5, 6, 7, wherein an inside material and an outside material are different at a part in which the thickness of said strip line conductor is relatively thick.

10. The dielectric laminated device according to claim 1, wherein a plurality of shield conductors are arranged in the interior of said layered product, and at least two resonators of the quarter wavelength tip shot-circuit type and a strip line conductor facing to part of said resonators of the quarter wavelength tip short-circuit type are arranged between said plurality of shield conductors, and the strip line conductor connects said two resonators of the quarter wavelength tip short-circuit type to each other and forms a multi-stage filter, and the thickness of part of said resonators of the quarter wavelength tip short-circuit type is thicker than that of the other part.

11. Communication equipment, comprising:
a transmitter; and
a receiver,
wherein the dielectric laminated device according to any one of claims 1, 2, 3, 5, 6, 7, 10 is included as an element.
